(19) United States
(12) Patent Application Publication
(10) Pub. No.: US 2008/0100615 A1
(43) Pub. Date: May 1, 2008

(54) SWEEP WITH GUIDE SURFACE

(75) Inventors: Kang Zhao, Ann Arbor, MI (US); Paul R. Lebovitz, Portland, OR (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: AUTODESK, INC., San Rafael, CA (US)

(21) Appl. No.: 11/553,634

(22) Filed: Oct. 27, 2006

(51) Int. Cl. G06T 17/00

(52) U.S. Cl. 345/420

(57) ABSTRACT

A method, apparatus, and article of manufacture provide the ability to conduct a sweep operation in a computer-implemented solid modeling system, A 3D non-planar surface is created. A path for a sweep operation is created. A profile for the sweep operation is created. The 3D surface is selected for use as a guide. An angle between the profile and the 3D non-planar surface is calculated. A sweep operation is conducted wherein a twist of the profile is maintained within a pre-defined range of the angle.

### CROSS-REFERENCE TO RELATED APPLICATIONS

This application is related to the following co-pending and commonly-assigned patent applications, which applications are incorporated by reference:

U.S. Pat. No. 6,906,711, filed on Jun. 21, 2001, and issued on Jun. 14, 2005 by Kenneth J. Hill, entitled “GRAPH-BASED METHOD FOR MULTI-BODIED SWEEP TERMINATIONS, which application claims priority to provisional patent application Ser. No. 60/269,831, filed on Feb. 20, 2001, by Kenneth J. Hill, entitled “GRAPH-BASED METHOD FOR MULTI-BODIED SWEEP TERMINATIONS,” and attorney's docket number 30566.126USP1.

### BACKGROUND OF THE INVENTION

1. Field of the Invention

The present invention relates to computer-aided design (CAD) systems, and in particular, to controlling the twist/roll of a sweep operation in a computer-implemented solid modeling system.

2. Description of the Related Art

Over the last few decades, designers have changed their fundamental approach to graphics design, moving from two-dimensional (2D) drawing systems to three-dimensional (3D) solid modeling systems. In such a solid modeling system, a feature or 3D solid may be created by moving a sketched profile along a spatial path in the model space. Thus, a 3D sweep command translates a cross-section along a path to form a 3D solid. The prior art provided enhanced sweep techniques to include the ability to scale and/or twist the cross section using a “rail” (another curve that is utilized to control the amount of scaling and/or twist). However, a sweep along a curved surface (e.g., across multiple surfaces and/or complex surfaces) can be extremely difficult to construct using rails and can often provide unexpected results. These problems may be better understood with a description of solid modeling and prior art sweep operations.

Solid modeling is a technique that allows designers to create dimensionally accurate 3D solid models in the 3D space represented within a computer, rather than traditional 2D drawings. 3D solid models include significantly more engineering data than 2D drawings do, including the volume, bounding surfaces, and edges of a design.

With the graphics capabilities of today's computers, these 3D solid models may be viewed and manipulated on a monitor. In addition to providing better visualization, 3D solid models may be used to automatically produce 2D drawing views, and can be shared with manufacturing applications and the like.

Some 3D solid modeling systems generate parametric feature-based models. A parametric feature-based model is comprised of intelligent features, such as holes, fillets, chamfers, etc. The geometry of the parametric feature-based model is defined by underlying mathematical formulations and inputs (i.e., parameters) rather than by geometric dimensions and relationships, which makes them easier to modify. These systems preserve design intent and manage it after every change to the model.

In solid modeling systems, a commonly used tool for creating parametric feature-based models is sweeping a profile along a path. Users typically draw a planar (not self-intersecting) profile of curves and then instruct the solid modeling system to sweep the profile along a specified path (e.g., linearly for extrusions and circularly for revolutions). The result of the profile sweep is a shaped solid body or part.

However, when the path crosses over multiple surfaces, the sweep operation may provide an unpredictable result because the profile is twisted or rolled in an undesirable manner. Consequently, there is a need in the art for new methods of controlling the roll/twist of a profile during a sweep operation in a solid modeling system.

Similar to the yaw, pitch, and roll of an aircraft in flight, a swept profile possesses three rotational degrees of freedom. FIG. 1 illustrates the rotational degrees of freedom for an aircraft. The roll of the aircraft is analogous to profile twist, while the combined pitch and yaw of the aircraft are equivalent to profile orientation.

Given a planar path, the profile need not twist and the feature provides expected results without the selection of a guide surface. FIG. 2 illustrates a planar sweep with expected results in accordance with the prior art. In the prior art, the user specifies a profile (e.g., a circle, rectangle, etc.). In FIG. 2, the specified profile comprises a rectangle. The user also specifies a curve (referred to as a path). The profile is often perpendicular to the path. When the sweep operation is performed, the profile is moved along the curve to create a 3D body. However, the user is not able to control the angle between the profile and the other geometry as the sweep is performed along the path. Nonetheless, in planar sweep operations, the results are as expected.

FIG. 3 illustrates a non-planar sweep conducted in the prior art. As illustrated, the ambiguity in the profile twist control can cause unexpected results 302. In this regard, as the profile is swept across the non-planar surfaces the profile twist causes the profile to change its orientation in an undesirable manner. The result 302 provides a cut (or an extrusion) on a surface in an unpredictable manner. In other words, as the profile is swept, the cut doesn't follow the surface as one would expect.

Nonetheless, in the prior art, the user could be presented with the capability to specify how a profile was positioned or rotated. In this regard, a profile orientation may be defined in a conventional single rail sweep by holding the profile normal to the path. However, an additional input is required to control the profile twist about the path in a non-planar sweep and it commonly resorts to the so-called minimum rotation twist control. The twist control of minimum rotation depends on the path only and it ignores any other geometry in modeling. Such a capability may also be available in the prior art in the form of a two-rail sweep operation. Two curves were provided with one curve controlling the rotation of the profile. However, in the prior art use of two rails, it is difficult and complex to construct the second curve. For example, to control the sweep in FIG. 3, a rail would need to be created so that it sits on the surface and moves along the surface exactly as the non-planar surface moves.

In view of the problems of the prior art, it is desirable to conduct a non-planar sweep operation (e.g., a sweep along a surface that curves in one or two directions) with the ability to control the profile twist. In other words, what is needed is a technique for constraining a profile twist during sweep operations to be able to generate predictable results for sweeps on curved surfaces.

### SUMMARY OF THE INVENTION

One or more embodiments of the invention provide the ability to create a Normal to Surface Sweep; a sweep feature that will allow the selection of a guide surface (in addition to a profile and a path), the normal of which will control the twist of the swept profile about the path.

With a guide surface selected, the profile will maintain a constant relationship with the selected surface as the profile is translated along the path. In this regard, the profile twists with regard to the guide surface.

### BRIEF DESCRIPTION OF THE DRAWINGS

Referring now to the drawings in which like reference numbers represent corresponding parts throughout:

FIG. 1 illustrates the rotational degrees of freedom for an aircraft;

FIG. 2 illustrates a planar sweep with expected results in accordance with the prior art;

FIG. 3 illustrates a non-planar sweep conducted in the prior art;

FIG. 4 is an exemplary hardware and software environment used to implement one or more embodiments of the invention;

FIG. 5 is a block diagram that illustrates the components of a graphics program in accordance with one or more embodiments of the invention;

FIG. 6 is a block diagram that illustrates the structure of an object list maintained by 3D databases in accordance with one or more embodiments of the invention;

FIG. 7 illustrates the use of the outside face of the cylinder as the guide surface/surface normal in accordance with one or more embodiments of the invention;

FIGS. 8A-8D illustrate the use of a sweep to conduct an extrusion operation in accordance with one or more embodiments of the invention;

FIGS. 9A-9D illustrates an additional example of the differences between a sweep with a surface normal and without a surface normal in accordance with one or more embodiments of the invention;

FIG. 10 illustrates the logical flow for conducting a sweep operation in accordance with one or more embodiments of the invention;

FIG. 11 illustrates a user interface that is used to select a normal to surface sweep operation in accordance with one or more embodiments of the invention;

FIG. 12 illustrates the use of multiple guide surfaces during a sweep operation to create an extrusion in accordance with one or more embodiments of the invention; and

FIGS. 13A and 13B illustrate an example of a normal to surface sweep wherein the tangency is maintained during the sweep operation in accordance with one or more embodiments of the invention.

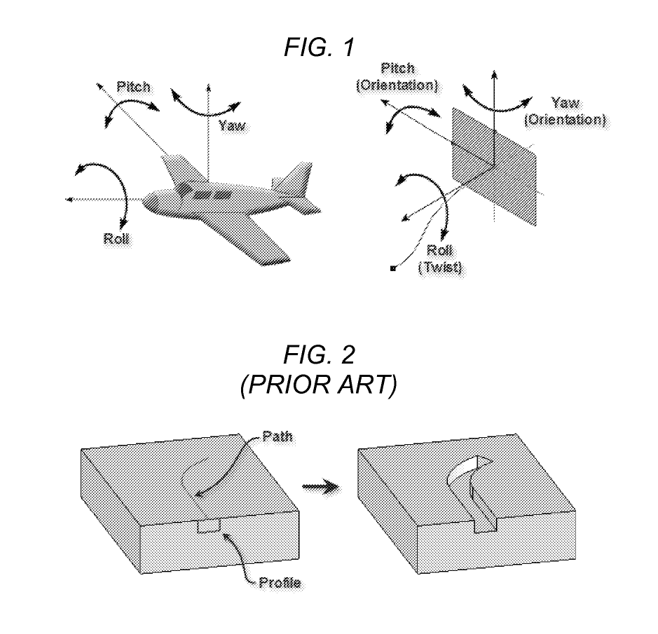

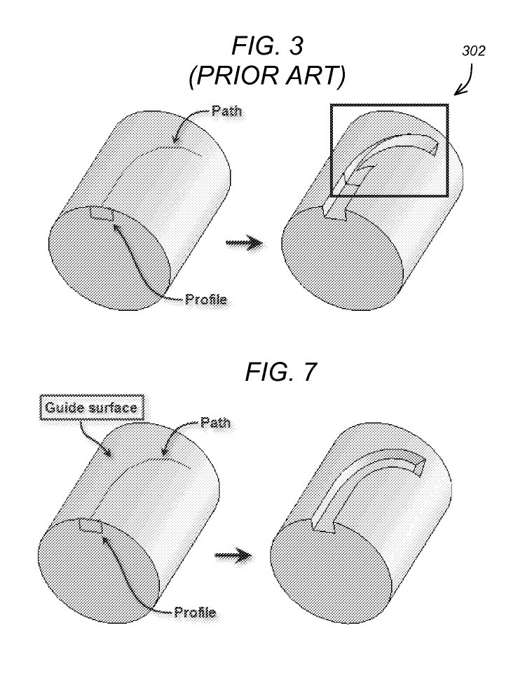

### DETAILED DESCRIPTION OF THE PREFERRED EMBODIMENTS

In the following description, reference is made to the accompanying drawings which form a part hereof, and which is shown, by way of illustration, an embodiment of the present invention. It is understood that other embodiments may be utilized and structural changes may be made without departing from the scope of the present invention.

Hardware and Software Environment

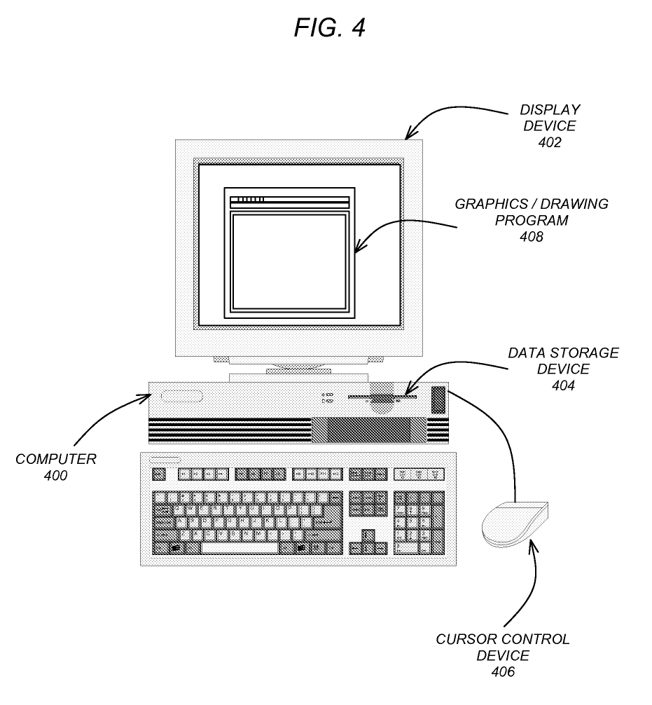

FIG. 4 is an exemplary hardware and software environment used to implement one or more embodiments of the invention. Embodiments of the invention are typically implemented using a computer 400, which generally includes, inter alia, a display device 402, data storage devices 404, cursor control devices 406, and other devices. Those skilled in the art will recognize that any combination of the above components, or any number of different components, peripherals, and other devices, may be used with the computer 400.

One or more embodiments of the invention are implemented by a computer-implemented graphics program 408, wherein the graphics program 408 is represented by a window displayed on the display device 402. Generally, the graphics program 408 comprises logic and/or data embodied in or readable from a device, media, carrier, or signal, e.g., one or more fixed and/or removable data storage devices 404 connected directly or indirectly to the computer 400, one or more remote devices coupled to the computer 400 via a data communications device, etc. In one or more embodiments of the invention, the graphics program 408 is a solid modeling program that is used to create dimensionally accurate 3D solid models in a 3D space represented within a computer, rather than traditional 2D drawings.

Those skilled in the art will recognize that the exemplary environment illustrated in FIG. 4 is not intended to limit the present invention. Indeed, those skilled in the art will recognize that other alternative environments may be used without departing from the scope of the present invention.

Computer-Implemented Graphics Program

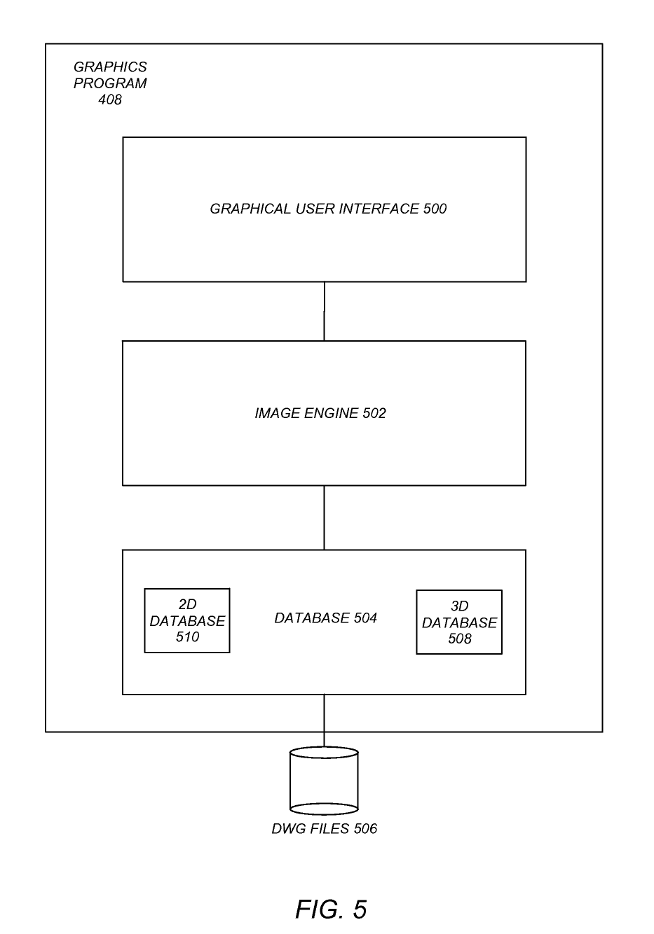

FIG. 5 is a block diagram that illustrates the components of the graphics program 408 in accordance with one or more embodiments of the invention. There are three main components to the graphics program 408, including: a Graphical User Interface (GUI) 500, an Image Engine (IME) 502, and a DataBase (DB) 504 for storing objects in Drawing (DWG) files 506.

The Graphical User Interface 500 displays information to the operator and provides the functionality for the operator's interaction with the graphics program 508.

The Image Engine 502 processes the DWG files 506 and delivers the resulting graphics to the monitor 402 for display. In one or more embodiments, the Image Engine 502 provides a complete application programming interface (API) that allows other computer programs to interface to the graphics program 408 as needed.

The Database 504 is comprised of two separate types of databases: (1) a 3D database 508 known as the “3D world space” that stores 3D information; and (2) one or more 2D databases 510 known as the “2D view ports” that stores 2D information derived from the 3D information.

Object List

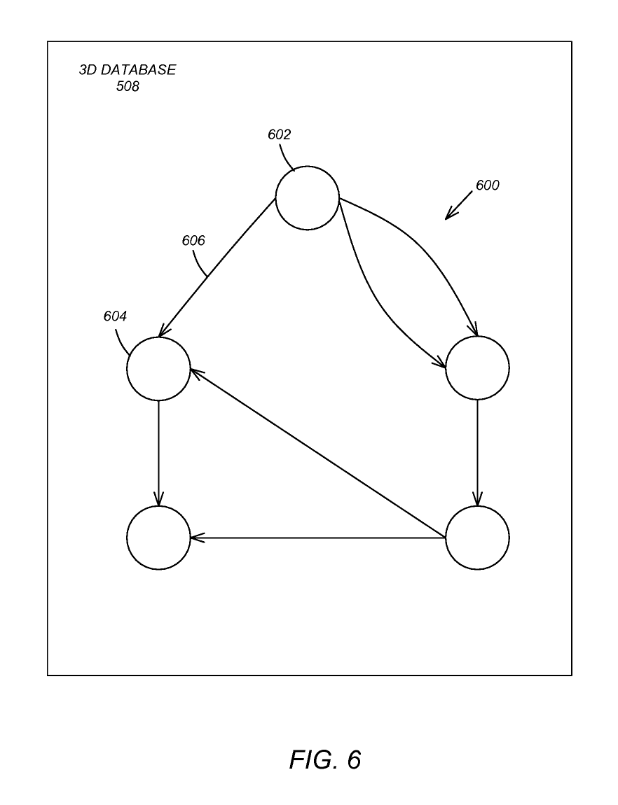

FIG. 6 is a block diagram that illustrates the structure of an object list 600 maintained by the 3D databases 508 in accordance with one or more embodiments of the invention. The object list 600 is usually comprised of a doubly linked list having a list head 602 and one or more objects 604 interconnected by edges 606, although other structures may be used as well. There may be any number of different object lists 600 maintained by the 3D databases 508. Moreover, an object 604 may be a member of multiple object lists 600 in the 3D databases 508.

Detailed Description of Sweep with Guide Surface

In accordance with one or more embodiments of the invention, the graphics program 108 provides the ability to conduct a sweep operation using a surface normal to guide and control the profile twist. A user identifies/selects a guide surface (in addition to a profile and a path). The normal of the selected guide surface controls the twist of the swept profile about the path. With the guide surface selected, a constant relationship is maintained between the profile and surface as it is translated along the path with the profile twisting with regard to the guide surface.

The normal of the selected surface may be viewed as an arrow or vector that points upwards orthogonal to the surface along the path and passes through the plane of the profile. The surface normal remains orthogonal in two (2) directions: (1) twist/yaw, and (2) pitch. However, while some embodiments provide for using an orthogonal surface normal, other embodiments, merely maintain the relationship/angle between the profile and the selected surface.

An example of the use of a surface normal can be described with respect to a cylinder. FIG. 3 illustrates a prior art sweep operation without using a surface normal. FIG. 7 illustrates the use of the outside face of the cylinder as the guide surface/surface normal. The surface normal changes along the path (i.e., the direction of the surface normal changes along the path). As the surface normal rotates, the profile rotates with the path in the same manner as the surface normal. Thus, the surface normal controls how the profile rotates. The right-side of FIG. 7 displays the resulting image when the normal to surface option has been selected by the user in accordance with one or more embodiments of the invention. Such a selection of a guide surface eliminates ambiguity in the profile twist and the desired feature/effect may be achieved.

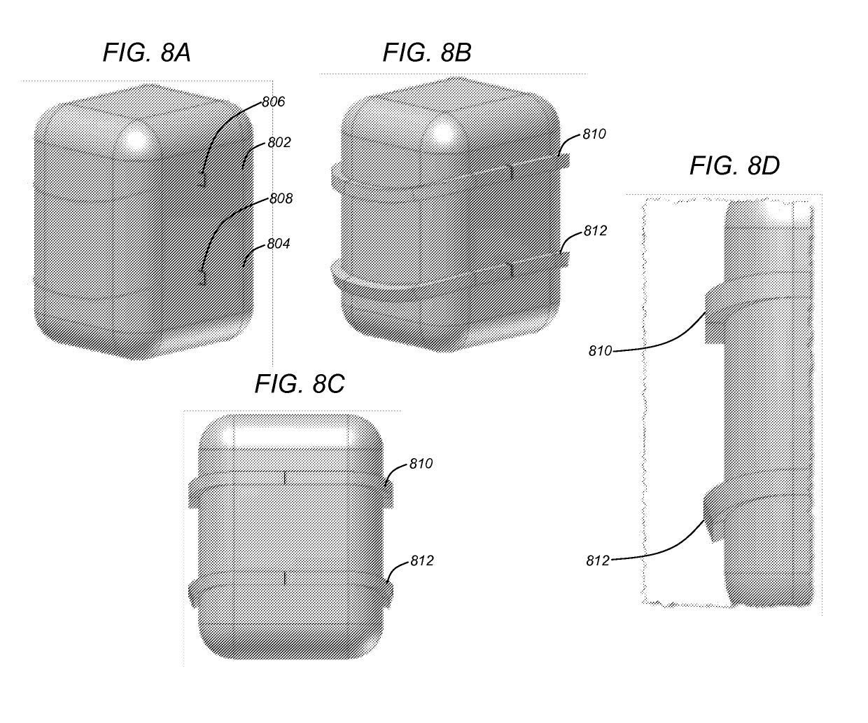

While FIGS. 3 and 7 illustrate the use of a sweep to conduct a cut operation, FIGS. 8A-8D illustrate the use of a sweep to conduct an extrusion operation. In FIG. 8A, two paths 802 and 804 and two profiles 806 and 808 are formed. FIGS. 8B, 8C, and 8D illustrate the differences between a sweep operation that utilizes a normal to surface constraint and a sweep operation that does not have a normal to surface constraint. Extrusion 810 has the normal to surface constraint active. As can be seen, the profile twist remains oriented in the same manner throughout the sweep along the path. However, extrusion 812 (i.e., the extrusion resulting from a sweep without a constraint to the surface normal) illustrates how the profile 808 twists in an undesirable manner. With the surface to normal constraint extrusion 810, the surface normal remains orthogonal to the surface throughout the sweep operation. However, in the prior art sweep operation, the resulting extrusion 812 rotates the profile twist as the path is traversed.

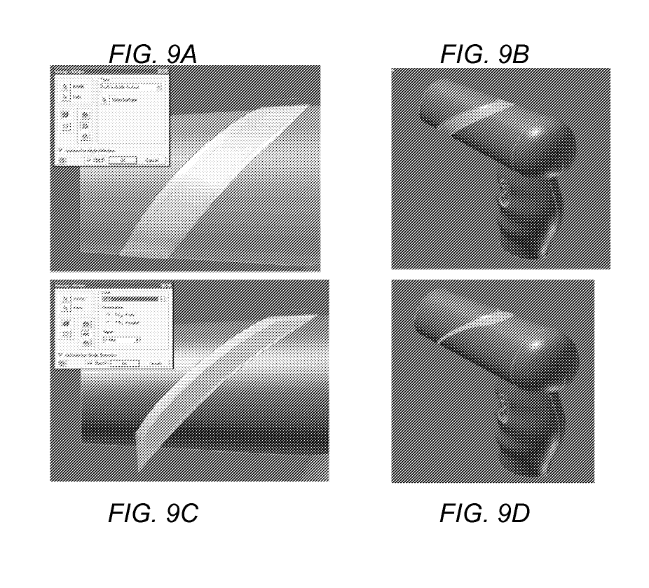

FIGS. 9A-9D illustrate an additional example of the differences between a sweep with a surface normal and without a surface normal. FIGS. 9A and 9B illustrate the cross section aligned to the model surface (i.e., the hair dryer), that has been selected as the guide surface. In FIGS. 9A and 9B, the sweep continually examines the guide surface and maintains a consistent relationship with the guide surface. FIGS. 9C and 9D illustrate what can happen when the cross section is not aligned, and twists unconstrained along the sweep path. In FIGS. 9C and 9D, there is no relationship between the profile as it is swept and the surface that is being swept along—thereby resulting in unpredictable behavior.

As described above, the relationship between the planar profile and the path/surface is angular. Embodiments of the invention examine the length of a path and the complexity of the surface in determining how often to examine the angular relationship and/or adjust the profile twist. For example, if the surface is merely planar, there is not a great need to sample the relationship every millimeter/pixel. In this regard, the more often that the relationship is examined, the more accurate the surface to normal sweep operation. The accuracy may be established/pre-defined by the system or may be adjustable by the user. Also of note is that while the guide surface controls the twist/roll, the pitch and yaw are maintained according to the path.

Logical Flow

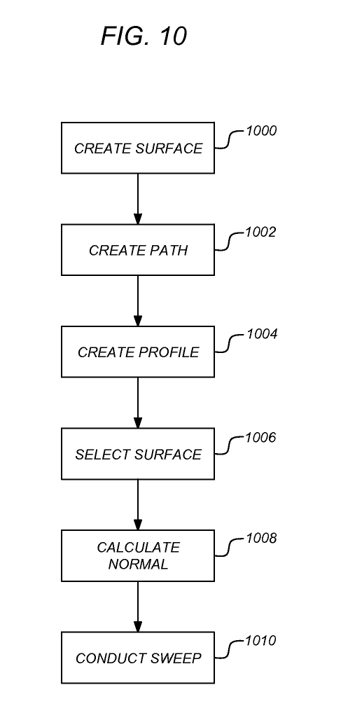

FIG. 10 illustrates the logical flow for conducting a sweep operation in accordance with one or more embodiments of the invention.

At step 1000, a user uses a tool to create a surface. Such a creation may consist of opening an already created surface or creating a new surface. Such a surface consists of a nonplanar surface as illustrated in FIGS. 3, 7, 8, and 9.

At step 1002, the user creates a curve or path. Such a curve or path may or may not lie on a face of the surface created at step 1002. In addition, the order of performing steps 1000 and 1002 may be interchangeable. For example, a path may be created prior to the surface. If a path is not on the surface, once a surface is created or associated with the path, a map is created wherein each point on the curve is associated with a point on the surface. In this regard, for each point on the curve, the closest point on the surface may be used.

At step 1004, a profile is created that is perpendicular/orthogonal to the path curve. Alternatively, a profile may be created on a plane such that the angle between the profile's plane and the normal vector at a particular point on the surface is maintained. Accordingly, when a profile is created, a work plane may be specified by the user on which the profile is established/created.

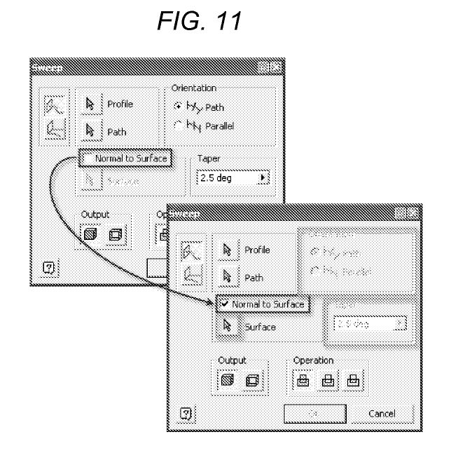

At step 1006, a surface is selected (e.g., by the user using a cursor control device) by which to constrain the sweep operation. This step may or may not be necessary. In this regard, the creation of the surface at step 1000 may incorporate this step such that the created surface is automatically selected. In addition, this step includes a step of the user activating the option to create a normal to surface sweep vs. a standard sweep operation. FIG. 11 illustrates a user interface that is used to select a normal to surface sweep operation. As illustrated, the user merely activates a checkbox to select a normal to surface sweep operation. Once the normal to surface sweep checkbox has been activated, the user may be prompted to select the desired guide surface to use during the sweep operation.

Once the path, surface, and profile have been created and identified, for use during the sweep operation, the normal may be calculated at step 1008. As described above, such a calculation may find the closest point on the surface for each point on the path. Once a point on the surface is identified, the surface normal for that point on the surface can be easily determined. In this regard, the normal is based on the angle established between the profile and the surface prior to initiating the sweep operation. Thus, this step includes calculating an angle between the profile and the 3D non-planar surface that has been selected.

As the sweep is conducted across the path (at step 1010), at designated points on the curve, the corresponding point on the surface is determined and the surface normal is used to rotate the profile twist appropriately. The entire curve may be defined with a specific set of points. Alternatively, the number of points used may be predefined within the graphics program or may be established via user input. The amount of twist applied to the profile is determined by the normal and angle calculation. In this regard, the twist may remain within a pre-defined range of the angle. Such a pre-defined range may be an equality, or a threshold level such that when the surface rotates beyond a certain amount, the profile will twist/rotate accordingly. As a result, the profile is rotated as the normal on the selected surface rotates while the profile is being swept.

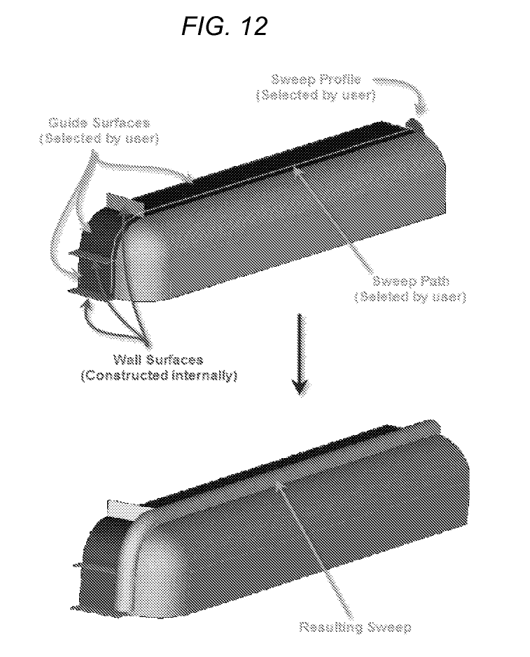

In addition to the use of a single face to use as a guide surface, additional embodiments provide the ability to sweep over multiple faces. Accordingly, at step 1006, multiple faces may be selected for use as guide surfaces. FIG. 12 illustrates the use of multiple guide surfaces during a sweep operation to create an extrusion. As described above, a path does not necessarily need to lie upon the faces selected as guide surfaces. A path that does not lie upon selected faces is projected onto those faces by the sweep operation. To perform such a projection, the sweep path may be broken into multiple segments, so that each segment is associated with the closest face.

As illustrated in FIG. 12, the path is broken into multiple segments by a series of internally constructed (not apparent to the user) “wall” surfaces at the adjoining boundaries of the faces. Wall surfaces are ruled surfaces defined by a face boundary and the face normals along the boundary. The path is clipped at each wall surface and each path segment is associated with a particular guide surface/face. Thus, clipping the path with the wall surfaces allows the sweep to associate a path segment to each face, thereby allowing predictable and robust projections for a more predictable and robust sweep.

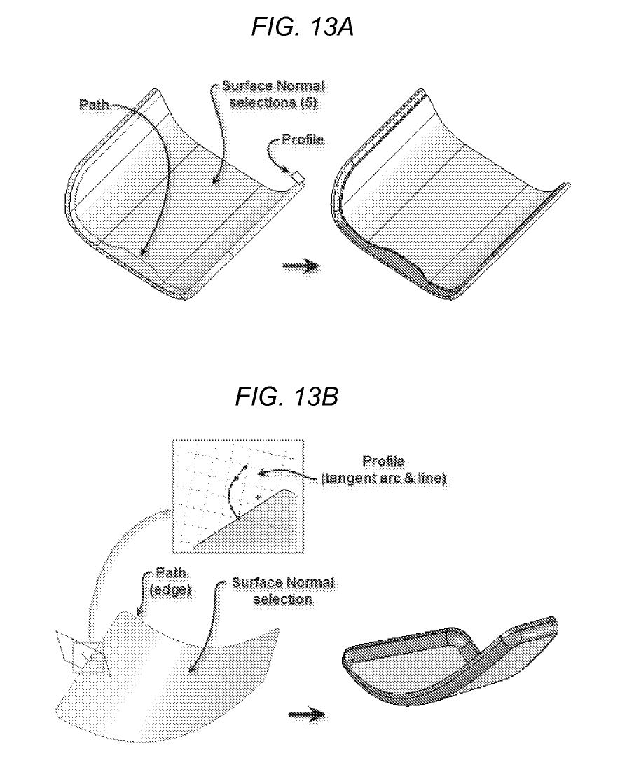

As described above, in one or more embodiments, the angle between the path and the profile (and/or the surface) are maintained during the sweep operation. In this regard, a tangent arc and line may be maintained. FIGS. 13A and 13B illustrate an example of a normal to surface sweep wherein the tangency is maintained during the sweep operation. In FIG. 13A, based on the selected surface normal selections, the angle of the profile to the path is maintained during the sweep operation. Similarly, in FIG. 13B, the profile comprises the tangent arc and line. The angle between the tangent arc and the path (i.e., around the outside of the selected surface) is maintained throughout the sweep operation.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention. In summary, embodiments of the invention provide the ability to conduct a sweep operation while controlling the profile twist based on a selected surface normal.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for conducting a sweep operation in a computer-implemented solid modeling system, comprising:
(a) creating a three-dimensional (3D) non-planar surface in a computer-implemented solid modeling system;
(b) creating a path for a sweep operation in the computer-implemented solid modeling system;
(c) creating a profile for the sweep operation in the computer-implemented solid modeling system;
(d) selecting the 3D non-planar surface for use as a guide during the sweep operation;
(e) calculating an angle between the profile and the 3D non-planar surface; and
(f) conducting a sweep operation wherein a twist of the profile is maintained within a pre-defined range of the angle.

2. The method of claim 1, wherein the twist of the profile is maintained by rotating the profile as a normal on the selected 3D non-planar surface rotates while the profile is being swept.

3. The method of claim 1, wherein the profile is orthogonal to the path.

4. The method of claim 1, wherein:
the path does not lie on the 3D non-planar surface; and
each point on the path is associated with a closest point on the 3D non-planar surface.

5. The method of claim 1, wherein the 3D non-planar surface is selected for use as a guide by a user.

6. The method of claim 1, further comprising:
selecting one or more additional 3D non-planar surfaces;
breaking up the path into multiple segments; and
associating each of the multiple segments with one of the additional 3D non-planar surfaces.

7. An apparatus for conducting a sweep operation in a computer system comprising:
(a) a computer; and
(b) a solid modeling system, executed by the computer, having logic for:
(i) creating a three-dimensional (3D) non-planar surface in a computer-implemented solid modeling system;
(ii) creating a path for a sweep operation in the computer-implemented solid modeling system;
(iii) creating a profile for the sweep operation in the computer-implemented solid modeling system;
(iv) selecting the 3D non-planar surface for use as a guide during the sweep operation;
(v) calculating an angle between the profile and the 3D non-planar surface; and
(vi) conducting a sweep operation wherein a twist of the profile is maintained within a pre-defined range of the angle.

8. The apparatus of claim 7, wherein the twist of the profile is maintained by rotating the profile as a normal on the selected 3D non-planar surface rotates while the profile is being swept.

9. The apparatus of claim 7, wherein the profile is orthogonal to the path.

10. The apparatus of claim 7, wherein:
the path does not lie on the 3D non-planar surface; and
each point on the path is associated with a closest point on the 3D non-planar surface.

11. The apparatus of claim 7, wherein the 3D non-planar surface is selected for use as a guide by a user.

12. The apparatus of claim 7, the logic further comprising:
selecting one or more additional 3D non-planar surfaces;
breaking up the path into multiple segments; and
associating each of the multiple segments with one of the additional 3D non-planar surfaces.

13. An article of manufacture comprising a program storage medium readable by a computer and embodying one or more instructions executable by the computer to perform a method for conducting a sweep operation in a solid modeling computer system, the method comprising:
(a) creating a three-dimensional (3D) non-planar surface in a computer-implemented solid modeling system;
(b) creating a path for a sweep operation in the computer-implemented solid modeling system;
(c) creating a profile for the sweep operation in the computer-implemented solid modeling system;
(d) selecting the 3D non-planar surface for use as a guide during the sweep operation;
(e) calculating an angle between the profile and the 3D non-planar surface; and
(f) conducting a sweep operation wherein a twist of the profile is maintained within a pre-defined range of the angle.

14. The article of manufacture of claim 13, wherein the twist of the profile is maintained by rotating the profile as a normal on the selected 3D non-planar surface rotates while the profile is being swept.

15. The article of manufacture of claim 13, wherein the profile is orthogonal to the path.

16. The article of manufacture of claim 13, wherein:
the path does not lie on the 3D non-planar surface; and
each point on the path is associated with a closest point on the 3D non-planar surface.

17. The article of manufacture of claim 13, wherein the 3D non-planar surface is selected for use as a guide by a user.

18. The article of manufacture of claim 13, the method further comprising:
selecting one or more additional 3D non-planar surfaces;
breaking up the path into multiple segments; and
associating each of the multiple segments with one of the additional 3D non-planar surfaces.
